(19) United States
(12) Patent Application Publication
(10) Pub. No.: US 2025/0229285 A1
(43) Pub. Date: Jul. 17, 2025

(54) Gardening water spray gun with replaceable sprinkler head

(71) Applicant: SHIN TAI SPURT WATER OF THE GARDEN TOOLS CO., LTD., Changhua County (TW)

(72) Inventor: Chin-Yuan Chen, Changhua County (TW)

(73) Assignee: SHIN TAI SPURT WATER OF THE GARDEN TOOLS CO., LTD., Changhua County (TW)

(21) Appl. No.: 18/412,681

(22) Filed: Jan. 15, 2024

(51) Int. Cl. B05B 15/652; B05B 1/12

(52) U.S. Cl. CPC B05B 15/652; B05B 1/12

(57) ABSTRACT

A gardening water spray gun with a replaceable sprinkler head including a water spray barrel, a sprinkler head, and a plurality of nozzles of different types. Two ends of the water spray barrel are formed a water inlet end and a water outlet end. One end of the sprinkler head is assembled on the water outlet end, and the other end of the sprinkler head forms a combination part to replaceably install the nozzle. A sleeve is provided at any position on the outer diameter of the water spray barrel. An arm extends from one side of the sleeve, and a combined seat is provided at the end of the arm. A joint part is formed at both the upper and lower ends of the combined seat for the nozzle to be coupled and positioned.

### BACKGROUND OF THE INVENTION

### Field of the Invention

This invention relates to a water spray gun, particularly to a gardening water spray gun that is easy to carry and has a replaceable sprinkler head.

### Description of the Related Art

The conventional water spray gun can be used for watering flowers, sprinkling water, washing floors, doors, windows, exterior walls, etc. In addition to replacing the previous direct water spraying method with a water hose, it also has an appropriate degree of pressurization.

The various types of water spray guns currently used have different nozzle accessories for easy replacement to meet the needs of different water output types such as columnar, linear, mist, circular, and even multi-lines. However, the conventional water spray gun does not have a special place to store the nozzles. It is usually placed in an empty box at home, in a drawer, or in a cabinet, instead of being stored near the water spray gun. It is easy to forget the actual location of the nozzles, causing extra time to find when replacing the nozzles that is inconvenience in use. If the replaced nozzle is not collected immediately, it may be forgotten, resulting in the loss of nozzle accessories and causing trouble in use.

### SUMMARY OF THE INVENTION

This invention provides a gardening water spray gun with a replaceable sprinkler head to solve the above-mentioned problems of the conventional gardening water spray gun.

This invention provides a gardening water spray gun with a replaceable sprinkler head including a water spray barrel, a sprinkler head, and a plurality of nozzles of different types. Two ends of the water spray barrel are formed a water inlet end and a water outlet end. One end of the sprinkler head is assembled on the water outlet end, and the other end of the sprinkler head forms a combination part to replaceably install the nozzle. A sleeve is provided at any position on the outer diameter of the water spray barrel. An arm extends from one side of the sleeve, and a combined seat is provided at the end of the arm. A joint part is formed at both the upper and lower ends of the combined seat for the nozzle to be coupled and positioned. Accordingly, the nozzle is placed on the water spray barrel to achieve the selection and replacement of the nozzle.

Further, the water inlet end is provided with a control valve.

Further, the water spray barrel includes a retractable outer tube and an inner tube. One end of the outer tube is further provided with a tightening ring for tightly fixing the inner tube.

Further, the combination part of the sprinkler head and the joint part of the combined seat are combined and fixed with the nozzle through a screw lock way.

Further, the combination part and the joint part are both provided with an external thread section, and one end of the nozzle is provided with an assembly part having an internal thread section, whereby the nozzle is installed on the combination part and the joint part through a screw lock way, and the other end of the nozzle has a water spray end of different types.

Further, the sprinkler head includes a pivot part to adjust the water spray angle of the sprinkler head.

Compared to the conventional art, the invention has the following advantages. The water spray end of the nozzle provides various water spray modes, such as jet-shaped water spray, column-shaped water spray, fan-shaped water spray, and scattering-shaped water spray. The nozzle is assembled in the combination part of the sprinkler head for use, and the remaining unused nozzles can be temporarily installed in the joint part of the combined seat, and can be carried and moved along with the water spray barrel. During use, the water source can be cut off at any time through the control valve, and the nozzle can be removed and replaced with other nozzle having other water spray modes. The replaced nozzle is directly installed on the joint part from which the nozzle has been removed, so that the purpose of storing the nozzle can be achieved, and the loss of the nozzle can be avoided, thereby improving the convenience of use of the water spray gun. In addition, during use, the water spray angle of the sprinkler head can be adjusted by utilizing the characteristic of the pivot part of the sprinkler head that can be rotated and positioned steplessly, thereby improving practicality.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional view of this invention.

FIG. 2 is an exploding view of this invention.

FIG. 3 is an exploding and cross-sectional view of this invention.

FIG. 4 is a cross-sectional view of the combined sprinkler head and nozzle of this invention.

FIG. 5 is a cross-sectional view of the combined sleeve and nozzle of this invention.

FIG. 6 is a three-dimensional view of the sprinkler head of this invention using one of the nozzles to spray water.

FIG. 7 is a schematic diagram of the adjustment angle of the sprinkler head of this invention.

FIG. 8 is a three-dimensional view of the sprinkler head of this invention replacing another one of the nozzles to spray water.

FIG. 9 is a cross-sectional view of the sprinkler head of this invention replacing another one of the nozzles to spray water.

### DETAILED DESCRIPTION OF THE INVENTION

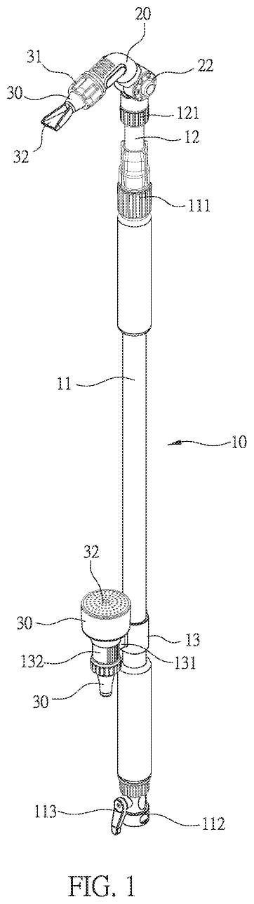

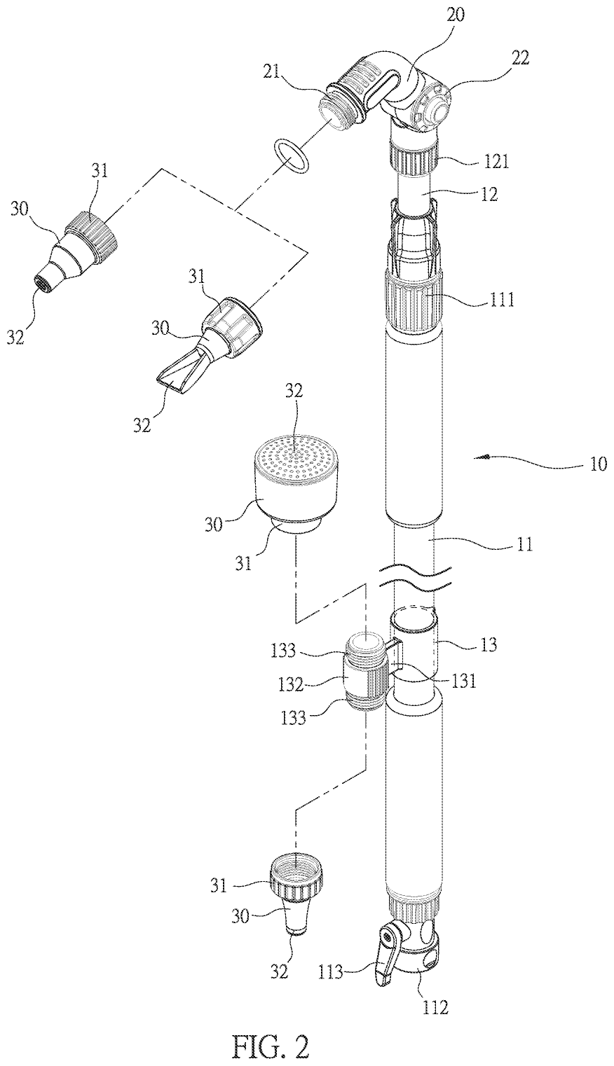

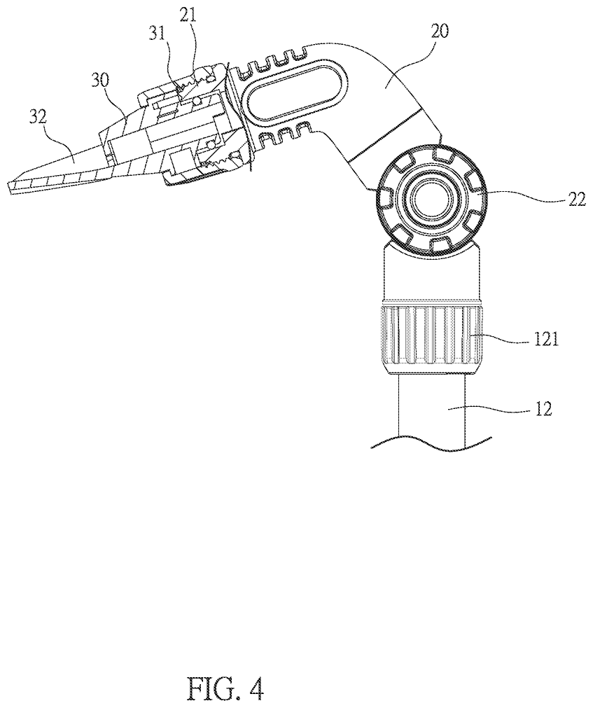

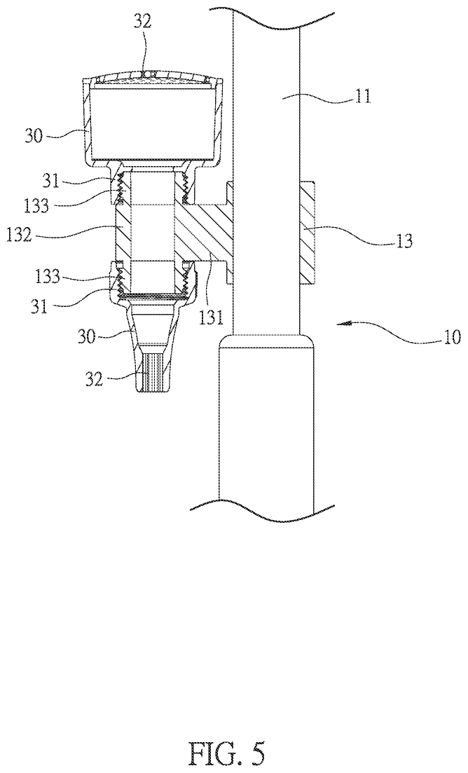

First, as shown in FIGS. 1-5, a gardening water spray gun with a replaceable sprinkler head includes a water spray barrel 10, a sprinkler head 20, and a plurality of nozzles 30 of different types. The water spray barrel 10 includes a retractable outer tube 11 and an inner tube 12. One end of the outer tube 11 is further provided with a tightening ring 111 for tightly fixing the inner tube 12. Two ends of the water spray barrel 10 are formed a water inlet end 112 at the bottom end of the outer tube 11 and a water outlet end 121 at the top end of the inner tube 12. The water inlet end 112 is further provided with a control valve 113. One end of the sprinkler head 20 is assembled on the water outlet end 121, and the other end of the sprinkler head 20 forms a combination part 21 to replaceably install the nozzle 30. The sprinkler head 20 further includes a pivot part 22 to adjust the water spray angle of the sprinkler head 20. A sleeve 13 is provided at any position on the outer diameter of the water spray barrel 10. An arm 131 extends from one side of the sleeve 13, and a combined seat 132 is provided at the end of the arm 131. A joint part 133 is formed at both the upper and lower ends of the combined seat 132 for the nozzle 30 to be coupled and positioned. Accordingly, the nozzle 30 is placed on the water spray barrel 10 to achieve the selection and replacement of the nozzle 30.

Secondly, the combination part 21 of the sprinkler head 20 and the joint part 133 of the combined seat 132 are combined and fixed with the nozzle 30 through a screw lock way, wherein the combination part 21 and the joint part 133 are both provided with an external thread section, and one end of the nozzle 30 is provided with an assembly part 31 having an internal thread section, whereby the nozzle 30 is installed on the combination part 21 and the joint part 133 through a screw lock way, and the other end of the nozzle 30 has a water spray end 32 of different types.

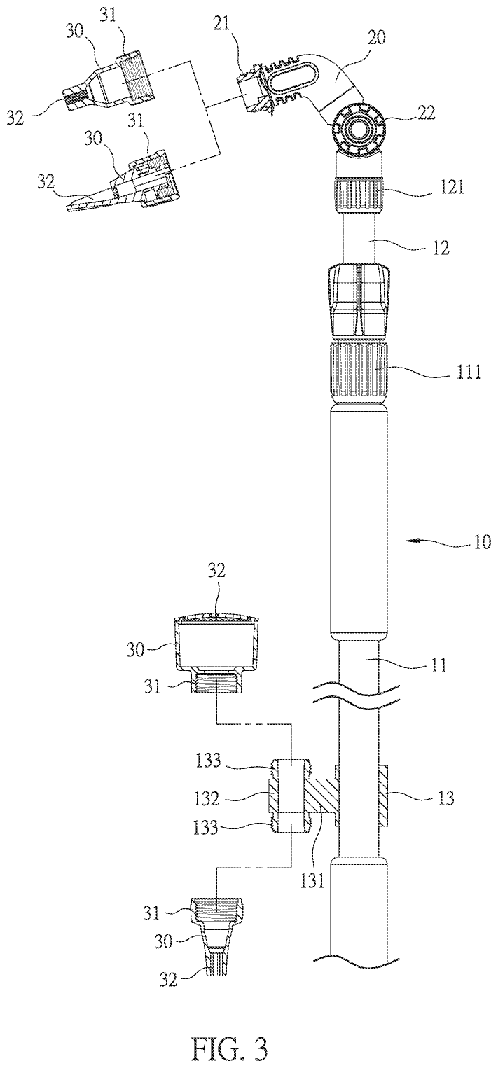

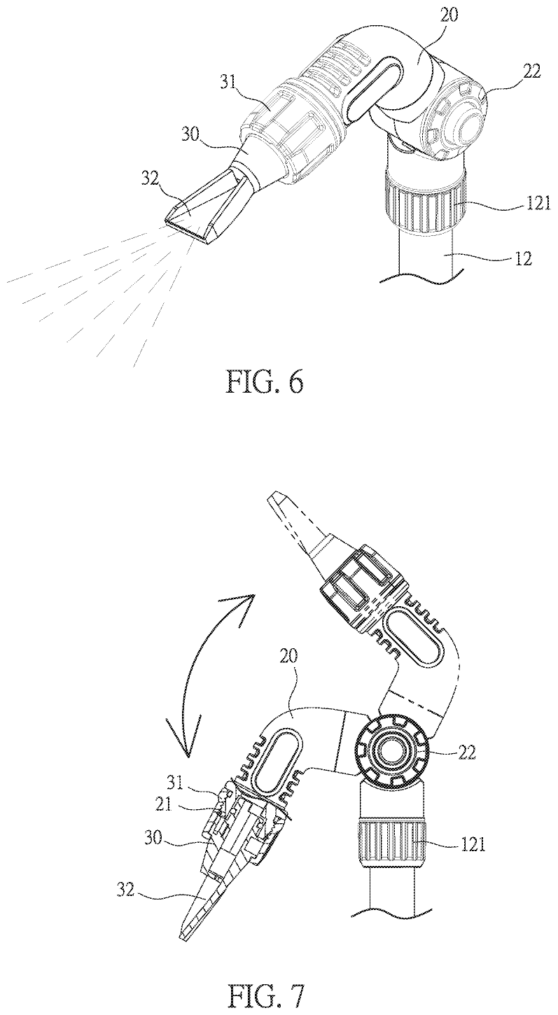

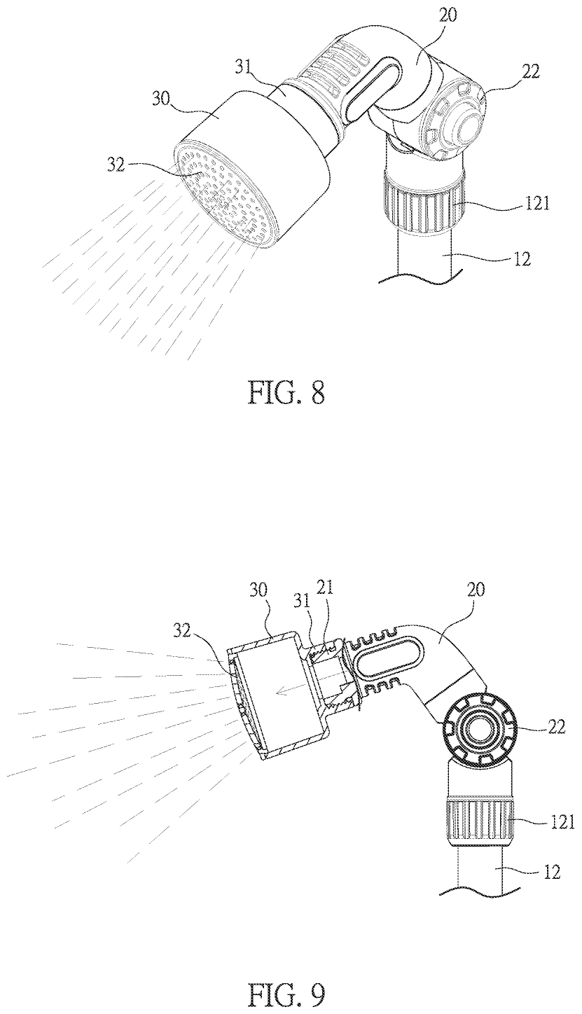

The actual use state of the structure is shown in FIGS. 3-5 and FIGS. 6-9. The water spray end 32 of the nozzle 30 provides various water spray modes, such as jet-shaped water spray, column-shaped water spray, fan-shaped water spray, and scattering-shaped water spray. The nozzle 30 is assembled in the combination part 21 of the sprinkler head 20 for use, and the remaining unused nozzles 30 can be temporarily installed in the joint part 133 of the combined seat 132, and can be carried and moved along with the water spray barrel 10. During use, the water source can be cut off at any time through the control valve 113, and the nozzle 30 can be removed and replaced with other nozzle 30 having other water spray modes. The replaced nozzle 30 is directly installed on the joint part 133 from which the nozzle 30 has been removed, so that the purpose of storing the nozzle 30 can be achieved, and the loss of the nozzle 30 can be avoided, thereby improving the convenience of use of the water spray gun. In addition, during use, the water spray angle of the sprinkler head 20 can be adjusted by utilizing the characteristic of the pivot part 22 of the sprinkler head 20 that can be rotated and positioned steplessly, thereby improving practicality.

What is claimed is:

1. A gardening water spray gun with a replaceable sprinkler head, comprising a water spray barrel, a sprinkler head, and a plurality of nozzles of different types, two ends of the water spray barrel are formed a water inlet end and a water outlet end, one end of the sprinkler head is assembled on the water outlet end, and the other end of the sprinkler head forms a combination part to replaceably install the nozzle, a sleeve is provided at any position on the outer diameter of the water spray barrel, an arm extends from one side of the sleeve, and a combined seat is provided at the end of the arm, a joint part is formed at both the upper and lower ends of the combined seat for the nozzle to be coupled and positioned, the nozzle is placed on the water spray barrel to achieve the selection and replacement of the nozzle.

2. The gardening water spray gun with a replaceable sprinkler head of claim 1, wherein the water inlet end is provided with a control valve.

3. The gardening water spray gun with a replaceable sprinkler head of claim 1, wherein the water spray barrel comprises a retractable outer tube and an inner tube, one end of the outer tube is further provided with a tightening ring for tightly fixing the inner tube.

4. The gardening water spray gun with a replaceable sprinkler head of claim 1, wherein the combination part of the sprinkler head and the joint part of the combined seat are combined and fixed with the nozzle through a screw lock way.

5. The gardening water spray gun with a replaceable sprinkler head of claim 4, wherein the combination part and the joint part are both provided with an external thread section, and one end of the nozzle is provided with an assembly part having an internal thread section, whereby the nozzle is installed on the combination part and the joint part through the screw lock way, and the other end of the nozzle has a water spray end of different types.

6. The gardening water spray gun with a replaceable sprinkler head of claim 1, wherein the sprinkler head comprises a pivot part to adjust the water spray angle of the sprinkler head.
